(19) United States
(12) Patent Application Publication
(10) Pub. No.: US 2007/0214183 A1
(43) Pub. Date: Sep. 13, 2007

(54) Methods for dynamic partitioning of a redundant data fabric

(75) Inventors: John Edward Howe, Saratoga, CA (US); Pralay Dakua, Fremont, CA (US)

Correspondence Address: HICKMAN PALERMO TRUONG & BECKER, LLP, 2055 GATEWAY PLACE, SUITE 550, SAN JOSE, CA, 95110, US

(73) Assignee: Omneon Video Networks

(21) Appl. No.: 11/371,393

(22) Filed: Mar. 8, 2006

(51) Int. Cl. G06F 17/30

(52) U.S. Cl. 707/200

(57) ABSTRACT

Quantitative data about storage load and usage from storage elements of a data storage system are collected. The storage elements are ranked according to the collected quantitative data. A partition across the storage elements in which to store a user requested file is determined. Members of the partition are identified as being one or more of the storage elements. The members are selected from the ranking. The ranking is updated in response to the ranking having aged or the system having been repaired or upgraded. Other embodiments are also described and claimed.

### FIELD

An embodiment of the invention is generally directed to electronic data storage systems that have high capacity, performance and data availability, and more particularly to ones that are scalable with respect to adding storage capacity and clients. Other embodiments are also described and claimed.

### BACKGROUND

In today's information intensive environment, there are many businesses and other institutions that need to store huge amounts of digital data. These include entities such as large corporations that store internal company information to be shared by thousands of networked employees; online merchants that store information on millions of products; and libraries and educational institutions with extensive literature collections. A more recent need for the use of large-scale data storage systems is in the broadcast television programming market. Such businesses are undergoing a transition, from the older analog techniques for creating, editing and transmitting television programs, to an all-digital approach. Not only is the content (such as a commercial) itself stored in the form of a digital video file, but editing and sequencing of programs and commercials, in preparation for transmission, are also digitally processed using powerful computer systems. Other types of digital content that can be stored in a data storage system include seismic data for earthquake prediction, and satellite imaging data for mapping.

A powerful data storage system referred to as a media server is offered by Omneon Video Networks of Sunnyvale, Calif. (the assignee of this patent application). The media server is composed of a number of software components that are running on a network of server machines. The server machines have mass storage devices such as rotating magnetic disk drives that store the data. The server accepts requests to create, write or read a file, and manages the process of transferring data into one or more disk drives, or delivering requested read data from them. The server keeps track of which file is stored in which drives. Requests to access a file, i.e. create, write, or read, are typically received from what is referred to as a client application program that may be running on a client machine connected to the server network. For example, the application program may be a video editing application running on a workstation of a television studio, that needs a particular video dip (stored as a digital video file in the system).

Video data is voluminous, even with compression in the form of, for example, Motion Picture Experts Group (MPEG) formats. Accordingly, data storage systems for such environments are designed to provide a storage capacity of hundreds of terabytes or greater. Also, high-speed data communication links are used to connect the server machines of the network, and in some cases to connect with certain client machines as well, to provide a shared total bandwidth of one hundred Gb/second and greater, for accessing the system. The storage system is also able to service accesses by multiple clients simultaneously.

To help reduce the overall cost of the storage system, a distributed architecture is used. Hundreds of smaller, relatively low cost, high volume manufactured disk drives (currently each unit has a capacity of one hundred or more Gbytes) may be networked together, to reach the much larger total storage capacity. However, this distribution of storage capacity also increases the chances of a failure occurring in the system that will prevent a successful access. Such failures can happen in a variety of different places, including not just in the system hardware (e.g., a cable, a connector, a fan, a power supply, or a disk drive unit), but also in software such as a bug in a particular client application program. Storage systems have implemented redundancy in the form of a redundant array of inexpensive disks (RAID), so as to service a given access (e.g., make the requested data available), despite a disk failure that would have otherwise thwarted that access. The systems also allow for rebuilding the content of a failed disk drive, into a replacement drive.

A storage system should also be scalable, to easily expand to handle larger data storage requirements as well as an increasing client load, without having to make complicated hardware ands software replacements.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 shows a data storage system, in accordance with an embodiment of the invention, in use as part of a video processing environment.

FIG. 2 shows a system architecture for the data storage system, in accordance with an embodiment of the invention.

FIG. 3 shows a network topology for an embodiment of the data storage system.

FIG. 4 shows a software architecture for the data storage system, in accordance with an embodiment of the invention.

FIG. 5 shows a block diagram describing a method for dynamic partitioning of a redundant data fabric, in accordance with an embodiment of the invention.

FIG. 6 shows an example grouping of the storage elements, in accordance with an embodiment of the invention.

FIG. 7 depicts a flow diagram of a process for updating the global list is shown.

### DETAILED DESCRIPTION

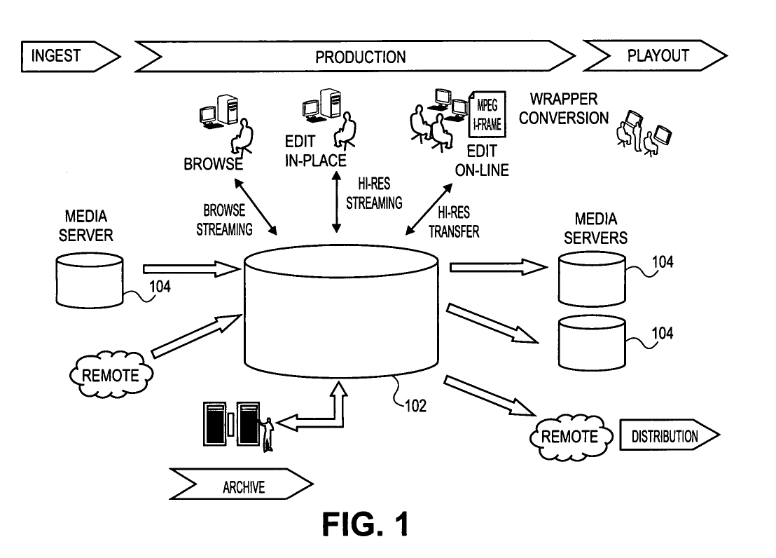

An embodiment of the invention is a data storage system that may better achieve demanding requirements of capacity, performance and data availability, with a more scalable architecture. FIG. 1 depicts such a storage system as part of a video and audio information processing environment. It should be noted, however, that the data storage system as well as its components or features described below can alternatively be used in other types of applications (e.g., a literature library; seismic data processing center; merchant's product catalog; central corporate information storage; etc.) The storage system 102, also referred to as an Omneon content library (OCL) system, provides data protection, as well as hardware and software fault tolerance and recovery.

The system 102 can be accessed using client machines or a client network that can take a variety of different forms. For example, content files (in this example, various types of digital media files including MPEG and high definition (HD)) can be requested to be stored, by a media server 104. As shown in FIG. 1, the media server 104can interface with standard digital video cameras, tape recorders, and a satellite feed during an “ingest” phase of the media processing, to create such files. As an alternative, the client machine may be on a remote network, such as the Internet. In the “production phase”, stored files can be streamed from the system to client machines for browsing, editing, and archiving. Modified files may then be sent from the system 102 to media servers 104, or directly through a remote network, for distribution, during a “playout” phase.

The OCL system provides a high performance, high availability storage subsystem with an architecture that may prove to be particularly easy to scale as the number of simultaneous client accesses increase or as the total storage capacity requirement increases. The addition of media servers 104 (as in FIG. 1) and a content gateway (to be described below) enables data from different sources to be consolidated into a single high performance/high availability system, thereby reducing the total number of storage units that a business must manage. In addition to being able to handle different types of workloads (including different sizes of files, as well as different client loads), an embodiment of the system 102 may have features including automatic load balancing, a high speed network switching interconnect, data caching, and data replication. According to an embodiment of the invention, the OCL system scales in performance as needed from 20 Gb/second on a relatively small, or less than 66 terabyte system, to over 600 Gb/second for larger systems, that is, over 1 petabyte. Such numbers are, of course, only examples of the current capability of the OCL system, and are not intended to limit the full scope of the invention being claimed.

An embodiment of the invention is an OCL system that is designed for non-stop operation, as well as allowing the expansion of storage, clients and networking bandwidth between its components, without having to shutdown or impact the accesses that are in process. The OCL system preferably has sufficient redundancy such that there is no single point of failure. Data stored in the OCL system has multiple replications, thus allowing for a loss of mass storage units (e.g., disk drive units) or even an entire server, without compromising the data. In contrast to a typical RAID system, a replaced drive unit of the OCL system need not contain the same data as the prior (failed) drive. That is because by the time a drive replacement actually occurs, the pertinent data (file slices stored in the failed drive) had already been saved elsewhere, through a process of file replication that had started at the time of file creation. Files are replicated in the system, across different drives, to protect against hardware failures. This means that the failure of any one drive at a point in time will not preclude a stored file from being reconstituted by the system, because any missing slice of the file can still be found in other drives. The replication also helps improve read performance, by making a file accessible from more servers.

To keep track of what file is stored where (or where are the slices of a file stored), the OCL system has a metadata server program that has knowledge of metadata (information about files) which includes the mapping between the file name of a newly created or previously stored file, and its slices, as well as the identity of those storage elements of the system that actually contain the slices.

In addition to mass storage unit failures, the OCL system may provide protection against failure of any larger, component part or even a complete component (e.g., a metadata server, a content server, and a networking switch). In larger systems, such as those that have three or more groups of servers arranged in respective enclosures or racks as described below, there is enough redundancy such that the OCL system should continue to operate even in the event of the failure of a complete enclosure or rack.

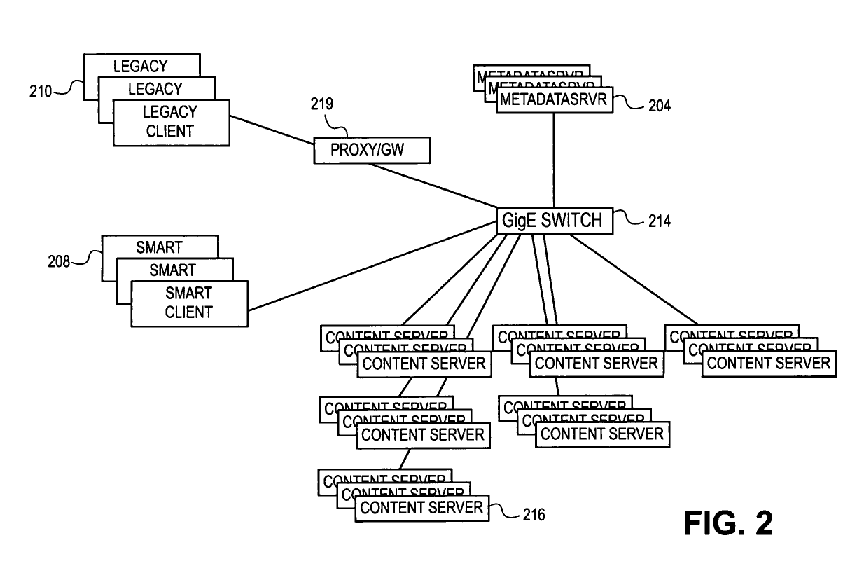

Referring now to FIG. 2, a system architecture for a data storage system connected to multiple clients is shown, in accordance with an embodiment of the invention. The system has a number of metadata server machines, each to store metadata for a number of files that are stored in the system. Software running in such a machine is referred to as a metadata server or metadata server 204. A metadata server may be responsible for managing operation of the OCL system and is the primary point of contact for clients. Note that there are two types of clients illustrated, a smart client 208 and a legacy client 210. A smart client has knowledge of a current interface of the system and can connect directly to a networking switch interconnect 214 (here a Gb Ethernet switch) of the system. The switch interconnect acts as a selective bridge between a number of content servers 216 and metadata servers 204 as shown. The other type of client is a legacy client that does not have a current file system driver (FSD) installed, or that does not use a software development kit (SDK) that is currently provided for the OCL system. The legacy client indirectly communicates with the system interconnect 214 through a proxy or content gateway 219 as shown, using a typical file system interface that is not specific to the OCL system.

The file system driver or FSD is software that is installed on a client machine, to present a standard file system interface, for accessing the OCL system. On the other hand, the software development kit or SDK allows a software developer to access the OCL directly from an application program. This option also allows OCL-specific functions, such as the replication factor setting described below, to be available to the user of the client machine.

In the OCL system, files are typically divided into slices when stored across multiple content servers (also referred to as content servers). Each content server runs on a different machine having its own set of one or more local disk drivers. This is the preferred embodiment of a storage element for the system. Thus, the parts of a file are spread across different disk drives, in different storage elements. In a current embodiment, the slices are preferably of a fixed size and are much larger than a traditional disk block, thereby permitting better performance for large data files (e.g., currently 8 Mbytes, suitable for large video and audio media files). Also, files are replicated in the system, across different drives, to protect against hardware failures. This means that the failure of any one drive at a point in time will not preclude a stored file from being reconstituted by the system, because any missing slice of the file can still be found in other drives. The replication also helps improve read performance, by making a file accessible from more servers. Each metadata server in the system keeps track of what file is stored where (or where are the slices of a file stored).

The metadata server determines which of the content servers are available to receive the actual content or data for storage. The metadata server also performs load balancing, that is determining which of the content servers should be used to store a new piece of data and which ones should not, due to either a bandwidth limitation or a particular content server filling up. To assist with data availability and data protection, the file system metadata may be replicated multiple times. For example, at least two copies may be stored on each metadata server machine (and, for example, one on each hard disk drive unit). Several checkpoints of the metadata are taken at regular time intervals. A checkpoint is a point in time snapshot of the file system or data fabric that is running in the system, and is used in the event of a system recovery. It is expected that on most embodiments of the OCL system, only a few minutes of time may be needed for a checkpoint to occur, such that there should be minimal impact on overall system operation.

In normal operation, all file accesses initiate or terminate through a metadata server. The metadata server responds, for example, to a file open request, by returning a list of content servers that are available for the read or write operations. From that point forward, client communication for that file (e.g., read; write) is directed to the content servers, and not the metadata servers. The OCL SDK and FSD, of course, shield the client from the details of these operations. As mentioned above, the metadata servers control the placement of files and slices, providing a balanced utilization of the content servers.

Although not shown in FIG. 2, a system manager may also be provided, executing for instance on a separate rack mount server machine, that is responsible for the configuration and monitoring of the OCL system.

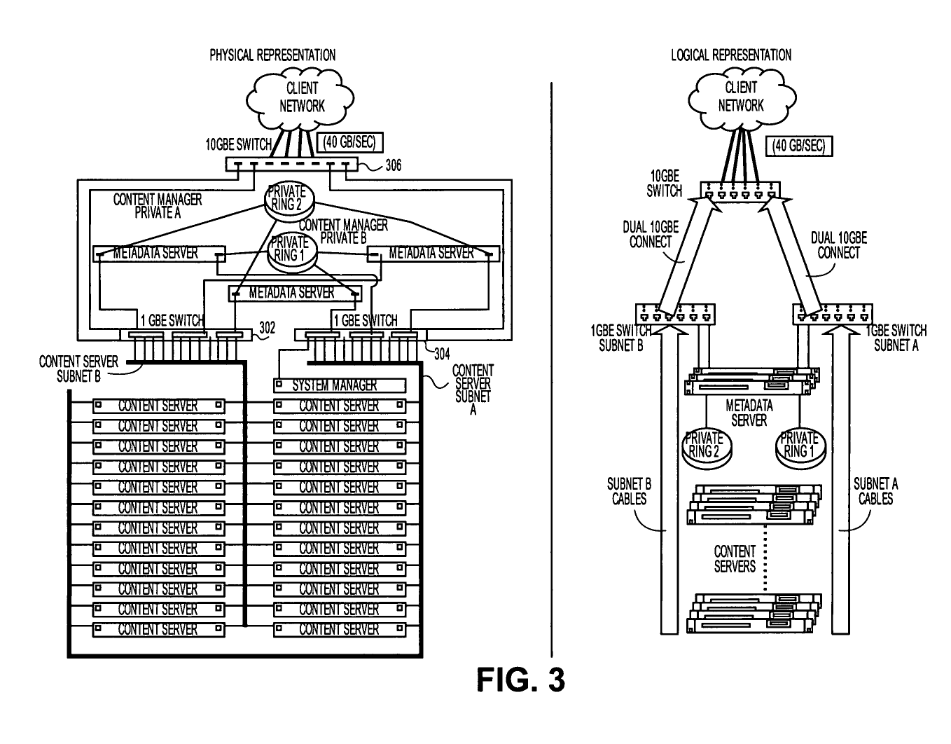

The connections between the different components of the OCL system, that is the content servers and the metadata servers, should provide the necessary redundancy in the case of a system interconnect failure. See FIG. 3 which also shows a logical and physical network topology for the system interconnect of a relatively small OCL system. The connections are preferably Gb Ethernet across the entire OCL system, taking advantage of wide industry support and technological maturity enjoyed by the Ethernet standard. Such advantages are expected to result in lower hardware costs, wider familiarity in the technical personnel, and faster innovation at the application layers. Communications between different servers of the OCL system preferably uses current, Internet protocol (IP) networking technology. However, other interconnect hardware and software may alternatively be used, so long as they provide the needed speed of transferring packets between the servers.

A networking switch is preferably used as part of the system interconnect. Such a device automatically divides a network into multiple segments, acts as a high-speed, selective bridge between the segments, and supports simultaneous connections of multiple pairs of computers which may not compete with other pairs of computers for network bandwidth. It accomplishes this by maintaining a table of each destination address and its port. When the switch receives a packet, it reads the destination address from the header information in the packet, establishes a temporary connection between the source and destination ports, sends the packet on its way, and may then terminate the connection.

A switch can be viewed as making multiple temporary crossover cable connections between pairs of computers. High-speed electronics in the switch automatically connect the end of one cable (source port) from a sending computer to the end of another cable (destination port) going to the receiving computer, for example on a per packet basis. Multiple connections like this can occur simultaneously.

In the example topology of FIG. 3, multi-Gb Ethernet switches 302, 304, 306 are used to provide the needed connections between the different components of the system. The current example uses 1 Gb Ethernet and 10 Gb Ethernet switches allowing a bandwidth of 40 Gb/second available to the client. However, these are not intended to limit the scope of the invention as even faster switches may be used in the future. The example topology of FIG. 3 has two subnets, subnet A and subnet B in which the content servers are arranged. Each content server has a pair of network interfaces, one to subnet A and another to subnet B, making each content server accessible over either subnet. Subnet cables connect the content servers to a pair of switches, where each switch has ports that connect to a respective subnet. Each of these 1 Gb Ethernet switches has a dual 10 Gb Ethernet connection to the 10 Gb Ethernet switch which in turn connects to a network of client machines.

In this example, there are three metadata servers each being connected to the 1 Gb Ethernet switches over separate interfaces. In other words, each 1 Gb Ethernet switch has at least one connection to each of the three metadata servers. In addition, the networking arrangement is such that there are two private networks referred to as private ring 1 and private ring 2, where each private network has the three metadata servers as its nodes. The metadata servers are connected to each other with a ring network topology, with the two ring networks providing redundancy. The metadata servers and content servers are preferably connected in a mesh network topology (see U.S. Patent Application entitled “Network Topology for a Scalable Data Storage System”, by Adrian Sfarti, et al.—P020, which is incorporated here by reference, as if it were part of this application. An example physical implementation of the embodiment of FIG. 3 would be to implement to each content server as a separate server blade, all inside the same enclosure or rack. The Ethernet switches, as well as the three metadata servers could also be placed in the same rack. The invention is, of course, not limited to a single rack embodiment. Additional racks filled with content servers, metadata servers and switches may be added to scale the OCL system.

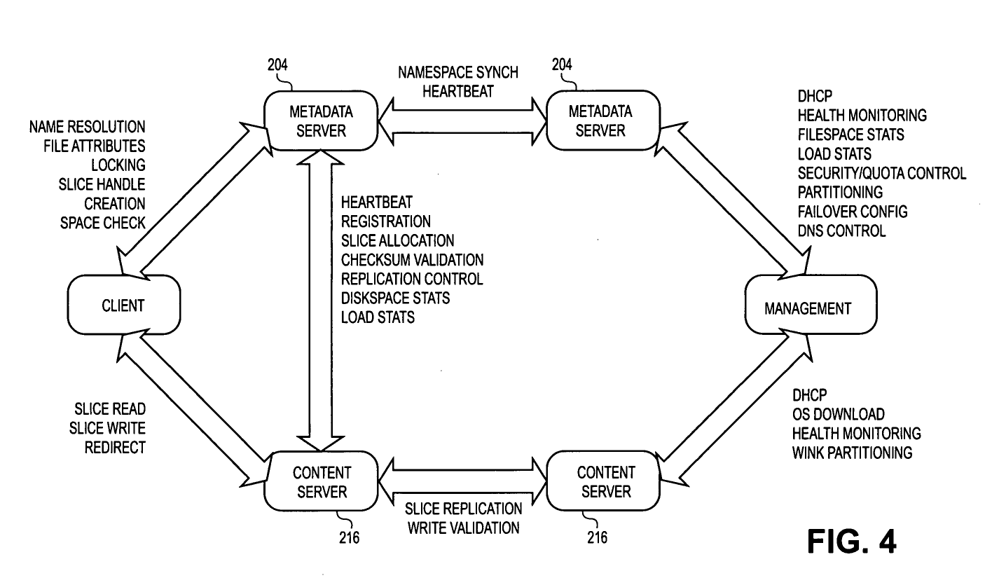

Turning now to FIG. 4, an example software architecture for the OCL system is depicted. The OCL system has a distributed file system program or data fabric that is to be executed in some or all of the metadata server machines, the content server machines, and the client machines, to hide complexity of the system from a number of client machine users. In other words, users can request the storage and retrieval of, in this case, audio and/or video information though a client program, where the file system or data fabric makes the OCL system appear as a single, simple storage repository to the user. A request to create, write, or read a file is received from a network-connected client, by a metadata server. The file system or data fabric software or, in this case, the metadata server portion of that software, translates the full file name that has been received, into corresponding slice handles, which point to locations in the content servers where the constituent slices of the particular file have been stored or are to be created. The actual content or data to be stored is presented to the content servers by the clients directly. Similarly, a read operation is requested by a client directly from the content servers.

Each content server machine or storage element may have one or more local mass storage units, e.g. rotating magnetic disk drive units, and its associated content server program manages the mapping of a particular slice onto its one or more drives. The file system or data fabric implements file redundancy by replication. In the preferred embodiment, replication operations are controlled at the slice level. The content servers communicate with one another to achieve slice replication and obtaining validation of slice writes from each other, without involving the client.

In addition, since the file system or data fabric is distributed amongst multiple machines, the file system uses the processing power of each machine (be it a content server, a client, or a metadata server machine) on which it resides. As described below in connection with the embodiment of FIG. 4, adding a content server to increase the storage capacity automatically increases the total number of network interfaces in the system, meaning that the bandwidth available to access the data in the system also automatically increases. In addition, the processing power of the system as a whole also increases, due to the presence of a central processing unit and associated main memory in each content server machine. Adding more clients to the system also raises the processing power of the overall system. Such scaling factors suggest that the system's processing power and bandwidth may grow proportionally, as more storage and more clients are added, ensuring that the system does not bog down as it grows larger.

Still referring to FIG. 4, the metadata servers are considered to be active members of the system, as opposed to being an inactive backup unit. In other words, the metadata servers of the OCL system are active simultaneously and they collaborate in the decision-making. This allows the system to scale to handling more clients, as the client load is distributed amongst the metadata servers. As the client load increases even further, additional metadata servers can be added.

An example of collaborative processing by multiple metadata servers is the validating of the integrity of slice information stored on a content server. A metadata server is responsible to reconcile any differences between its view and the content server's view of slice storage. These views may differ when a server rejoins the system with fewer disks, or from an earlier usage time. Because many hundreds of thousands of slices can be stored on a single content server, the overhead in reconciling differences in these views can be sizeable. Since content server readiness is not established until any difference in these views is reconciled, there is an instant benefit in minimizing the time to reconcile any differences in the slice views. Multiple metadata servers will partition that part of the data fabric supported by such a content server and concurrently reconcile different partitions in parallel. If during this concurrency a metadata server faults, the remaining metadata servers will recalibrate the partitioning so that all outstanding reconciliation is completed. Any changes in the metadata server slice view is shared dynamically among all active metadata servers.

Another example is jointly processing large scale re-replication when one or multiple content servers can no longer support the data fabric. Large scale re-replication implies additional network and processing overhead. In these cases, the metadata servers dynamically partition the re-replication domain and intelligently repair the corresponding “tears” in the data fabric and corresponding data files so that this overhead is spread among the available metadata servers and corresponding network connections.

Another example is jointly confirming that one or multiple content servers can no longer support the data fabric. In some cases, a content server may become partly inaccessible, but not completely inaccessible. For example, because of the built in network redundancy, a switch component may fail. This may result in some but not all metadata servers to loose monitoring contact with one or multiple content servers. If a content server is accessible to at least one metadata server, the associated data partition subsets need not be re-replicated. Because large scale re-replication can induce significant processing overhead, it is important for the metadata servers to avoid re-replicating unnecessarily. To achieve this, metadata servers exchange their views of active content servers within the network. If one metadata server can no longer monitor a particular content server, it will confer with other metadata servers before deciding to initiate any large scale re-replication.

According to an embodiment of the invention, the amount of replication (also referred to as “replication factor”) is associated individually with each file. All of the slices in a file preferably share the same replication factor. This replication factor can be varied dynamically by the user. For example, the OCL system's application programming interface (API) function for opening a file may include an argument that specifies the replication factor. This fine grain control of redundancy and performance versus cost of storage allows the user to make decisions separately for each file, and to change those decisions over time, reflecting the changing value of the data stored in a file. For example, when the OCL system is being used to create a sequence of commercials and live program segments to be broadcast, the very first commercial following a halftime break of a sports match can be a particularly expensive commercial. Accordingly, the user may wish to increase the replication factor for such a commercial file temporarily, until after the commercial has been played out, and then reduce the replication factor back down to a suitable level once the commercial has aired.

Another example of collaboration by the metadata servers occurs when a decrease in the replication factor is specified. In these cases, the global view of the data fabric is used to decide which locations to release according to load balancing and data availability and network paths.

According to another embodiment of the invention, the content servers in the OCL system are arranged in groups. The groups are used to make decisions on the locations of slice replicas. For example, all of the content servers that are physically in the same equipment rack or enclosure may be placed in a single group. The user can thus indicate to the system the physical relationship between content servers, depending on the wiring of the server machines within the enclosures. Slice replicas are then spread out so that no two replicas are in the same group of content servers. This allows the OCL system to be resistant against hardware failures that may encompass an entire rack.

Replication

Replication of slices is preferably handled internally between content servers. Clients are thus not required to expend extra bandwidth writing the multiple copies of their files. In accordance with an embodiment of the invention, the OCL system provides an acknowledgment scheme where a client can request acknowledgement of a number of replica writes that is less than the actual replication factor for the file being written. For example, the replication factor may be several hundred, such that waiting for an acknowledgment on hundreds of replications would present a significant delay to the client's processing. This allows the client to tradeoff speed of writing verses certainty of knowledge of the protection level of the file data. Clients that are speed sensitive can request acknowledgement after only a small number of replicas have been created. In contrast, clients that are writing sensitive or high value data can request that the acknowledgement be provided by the content servers only after all specified number of replicas have been created.

Intelligent Slices

According to an embodiment of the invention, files are divided into slices when stored in the OCL system. In a preferred case, a slice can be deemed to be an intelligent object, as opposed to a conventional disk block or stripe that is used in a typical RAID or storage area network (SAN) system. The intelligence derives from at least two features. First, each slice may contain information about the file for which it holds data. This makes the slice self-locating. Second, each slice may carry checksum information, making it self-validating. When conventional file systems lose metadata that indicates the locations of file data (due to a hardware or other failure), the file data can only be retrieved through a laborious manual process of trying to piece together file fragments. In accordance with an embodiment of the invention, the OCL system can use the file information that are stored in the slices themselves, to automatically piece together the files. This provides extra protection over and above the replication mechanism in the OCL system. Unlike conventional blocks or stripes, slices cannot be lost due to corruption in the centralized data structures.

In addition to the file content information, a slice also carries checksum information that may be created at the moment of slice creation. This checksum information is said to reside with the slice, and is carried throughout the system with the slice, as the slice is replicated. The checksum information provides validation that the data in the slice has not been corrupted due to random hardware errors that typically exist in all complex electronic systems. The content servers preferably read and perform checksum calculations continuously, on all slices that are stored within them. This is also referred to as actively checking for data corruption. This is a type of background checking activity which provides advance warning before the slice data is requested by a client, thus reducing the likelihood that an error will occur during a file read, and reducing the amount of time during which a replica of the slice may otherwise remain corrupted.

Dynamic Partitioning of a Redundant Data Fabric

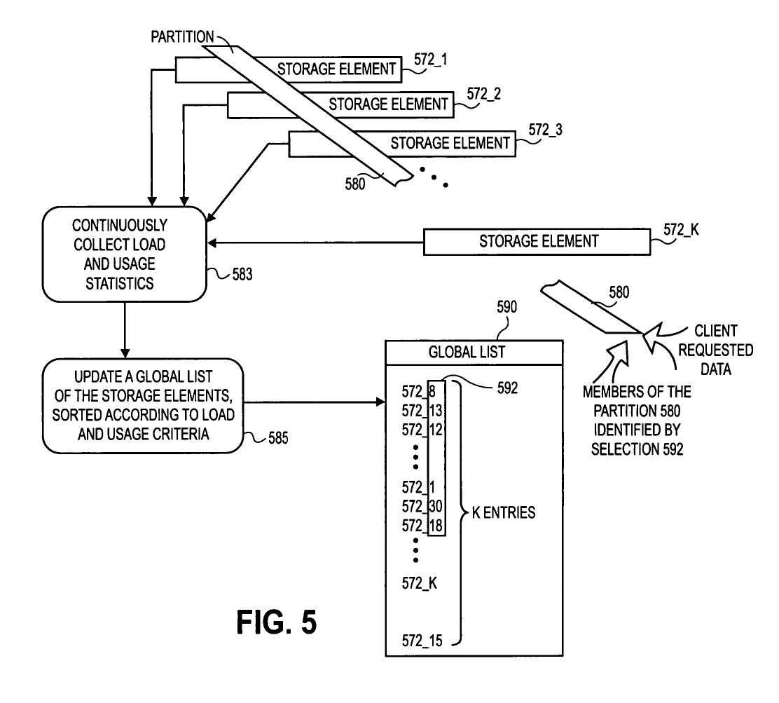

Turning now to FIG. 5, a block diagram describing a method for dynamic partitioning of a redundant data fabric, in accordance with an embodiment of the invention is shown. The data fabric is part of a data storage system that has a number of metadata server machines each to store metadata for files that are stored in the system, and a number of storage elements to store slices of the files at locations indicated by the metadata. This figure shows storage elements 572_1, 572_2, . . . 572_K that make up the system, but does not show other components. See, for example, FIG. 3 which shows an example data storage system having metadata server machines, storage elements, and a system interconnect to which the server machines and storage elements are communicatively coupled. The data fabric is to be executed in some or all of these hardware components, and it is designed to hide complexity of the system from client users.

The data fabric also has software that is to be executed preferably in one of the metadata server machines, to determine a partition across the storage elements 572_1, 572_2, . . . 572_K, in which to store client requested data. The data may be for a client request to create a new file and write its associated write data into storage. A partition 580 is to be determined that has data storage space distributed among several of the storage elements 572. The software identifies which of the storage elements 572 are to be the members of the partition 580. As an example, there may be several hundred storage elements 572, and, given the permitted size of a slice in the system and the type of file requested to be opened by the client or the amount of data requested to be stored, a subset of the K storage elements 572 may be sufficient to fill the requested partition size. The system thus needs to determine or identify which of the K storage elements 572 are to be the members of the partition 580, for a particular client request.

Still referring to FIG. 5, the dynamic partitioning process proceeds with operation 583 where the software continuously collects load and usage statistics for the system as a whole, and in particular the storage elements 572. Referring back to FIG. 3, an embodiment of the invention includes a message-based control path from each storage element or content server, to a centralized metadata server. The control path may be over a separate bus (e.g., separate from the multi-Gb Ethernet links that connect the network interface ports of the switches and servers in FIG. 3). This control path is used by software in the metadata server machines, to continuously collect as the system is run, storage load, including storage availability, and usage statistics for the storage elements of the system. The metadata server software then calculates the global availability of the data fabric. This may be done in operation 585 in FIG. 5, where a global list 590 of the storage elements is updated. The global list 590 is a list of all storage elements or content servers in the system, sorted according to one or more load and usage criteria. This allows a client program of the storage system to request a partition that is deemed “globally optimal” from the global list 590. For example, the top fifty storage elements identified in the global list 590 may be selected to become members of the requested partition 580. This is depicted in FIG. 5 as selection 592, which is a subset of the K sorted entries that are in the global list 590. Once the partition 580 has been determined in this manner, the client requested data may then be written as one or multiple copies, to the defined partition 580.

By globally calculating optimal availability of the data fabric on centralized and redundant metadata servers, the method is faster to recognize and accommodate changes in storage element accessibility. Since the metadata servers also have apriori knowledge of scheduled services involving storage elements, and allocation of storage elements for near term data fabric repair, a global formulation of the global list is more comprehensive than methods that may be distributed over the storage elements.

The availability of the data fabric is a dynamic composite that is a continuously changing combination of the storage load and storage element usage statistics in the system. Software running in the metadata server machines is also responsible for repairing the data fabric, by re-replicating copies of data throughout the data fabric. Knowledge of the amount of repair work that has been queued up for a particular content server, for example, may also be used to predict the availability of storage elements during the course of formulating the optimal availability partition.

The storage load and usage criteria for which statistics are to be collected may include the following:
The degree to which a storage element has joined the data fabric;
The number of times a storage element has been referenced in a partition;
The degree to which a storage element is committed to data fabric repair;
The fullness of a data cache in a storage element;
The amount of free space in a storage element;
The amount of read and writes performed by a storage element on behalf of a client of the system;
The depth of a request queue in a storage element;
The number of writes that are pending for a storage element to repair the data fabric on behalf of the metadata servers;
The number of data errors recently logged by a storage element;
The number of connectivity errors tracked by each metadata server; and
The time required to complete control commands between the metadata servers and content servers.

Additional examples of the collected storage load and usage statistics are:
The number of outstanding data fabric repairs that involve the storage element;
Whether environment conditions are approaching operating limitations, e.g. ambient temperature of the storage element, number of remaining backup power supplies, number of operating fans; and
The nearness of a storage element being allocated for internal integrity services, such as being targeted as the destination of a backup of checkpoint images of metadata server tables.

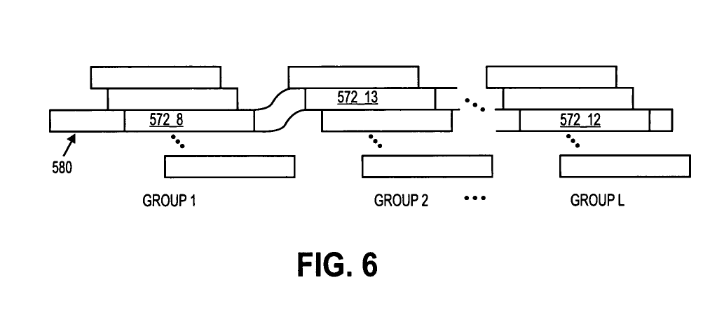

Referring now to FIG. 6, the storage elements 572 of the system can be statically grouped as shown. The software preferably selects the members of the partition 580, so that each of the members is from a different group. As can be seen in FIG. 6, this means that the first L members of the partition 580, where L is the total number of groups of storage elements in the system, are each in a different group. The grouping of storage elements may be in accordance with common installation parameters, e.g. power source, model type, and connectivity to a particular switching topology. Each group has a respective two or more of the storage elements 572 that have such common installation parameters. For example, in FIG. 6, Group 1 may be a set of storage elements (in this case, including storage element 572_8) that are in the same rack or enclosure, sharing the same power supply. Those in Group 2 would be in a different rack, sharing a different power source. Another grouping methodology may be to place all storage elements that have disk drives of a particular model type in the same group. In another methodology, those storage elements that are connected to a first external packet switch of the system are grouped separately than those storage elements that are connected to a second external packet switch. As explained below, this type of static grouping determines a “stride” within the entire set of storage elements of the system from which members of a given partition are to be selected.

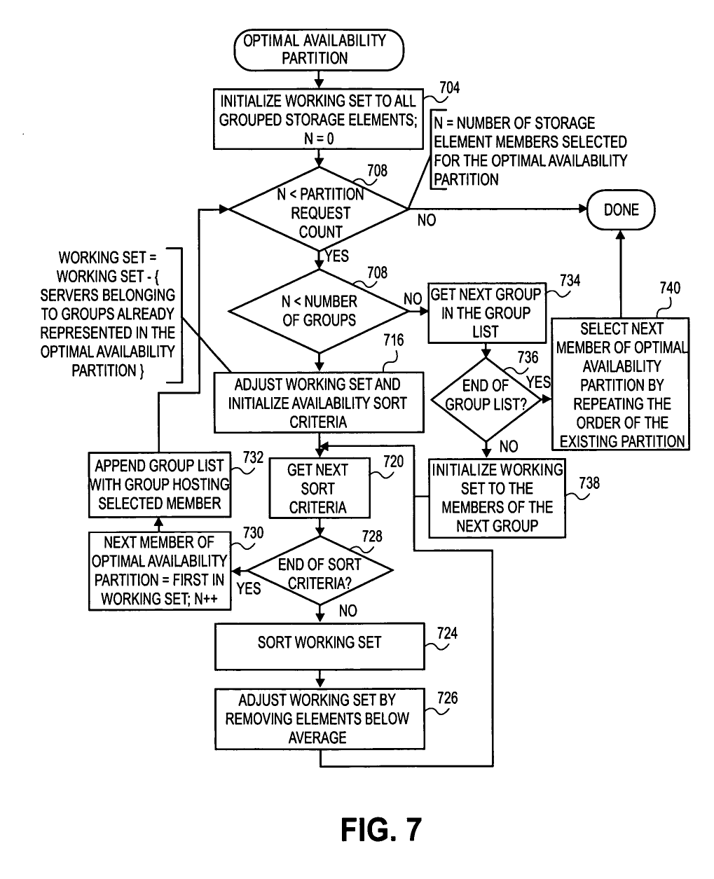

Turning now to FIG. 7, a flow diagram of a process for determining the global availability partition or global list 590 (see FIG. 5) is shown. The global list 590 is preferably cached in each of the metadata server machines of the system, together with software that is to respond to a client request for a new partition by selecting members of the new partition from the cached global list. As clients request an availability partition, the software associated with the metadata servers respond by allocating a segment of the optimal availability partition to the requesting client. Such responses by the metadata servers continue until the globally held optimal availability partition or global list has either aged or the data fabric has been significantly altered. The global list 590 is updated, for example, when there has been a change in the storage elements or in the system interconnect, e.g. a disk drive of a given storage element has failed and has been replaced, or there has been an upgrade to the system in terms of increase of storage capacity or bandwidth capability.

Such changes in the data fabric are recognized by a combination of periodic monitoring of storage elements by the metadata servers, and event driven notifications from a storage element to the metadata servers. Storage elements can dynamically connect, disconnect, or reconnect to the data fabric, thereby altering the selection of the optimal availability partition. Changes in the configuration of the storage, such as hot swapping a disk drive, will also alter the selection of the optimal availability partition.

Referring to FIG. 7 now, the process to determine the “optimal” availability partition or global list 590 may begin with initializing a working set to all grouped storage elements of the system (704). The variable N refers to the partition request count, and is used to indicate the total number of storage element members that have been selected for the global list or global partition (initialized to zero). A partition request count is defined based on, for example, the largest expected client request, e.g. based on the types of file that are requested or the maximum size of a file.

While the number of storage element members that have been selected for the global partition is less than the request count (708), the process determines whether the number of storage element members selected up until now for the partition are less than the number of groups in the system (712). As mentioned above, the storage elements of the system can be arranged into groups based on the members of each group having one or more common installation parameters. If the number of members selected for the partition are less than the number of groups, then the working set is adjusted by removing any storage elements or servers that belong to groups already represented in the partition (716). With the first pass, there is no adjustment to the working set such that operation then proceeds with initializing the availability sort criteria (716). The sort criteria includes several of the storage load and usage criteria described above. For a particular one of the sort criteria (720), the working set is sorted (724). For instance, assume the sort criteria in this pass is the degree to which a storage element has joined the data fabric, meaning number of active network connections, connection speed, and connectivity errors. The working set is then adjusted, by removing those elements that are below a certain threshold, that is below “optimal”, e.g. below average. The process then loops back to operation 720 where the next sort criteria is obtained and the working set is again sorted (724), and again adjusted by removing elements that are below optimal (726). This loop continues to be repeated until the sort criteria have been depleted (728), at which point the next member of the partition is selected (730). The selected member in this example is the first or top ranked member of the remaining working set (730). The variable N (the number of storage element members selected for the optimal availability partition) is incremented (730), and the group that is hosting the just selected member is appended to a group list (732).

The above-described process beginning with operation 708 is then repeated, to select the next member of the partition. Note that in operation 716, the working set is reinitialized each time, by removing any servers or storage elements that belong to groups that are already represented in the partition.

When the number of members in the partition reaches the number of static groups (operation 712), the next member is selected so that the group order is repeated. Thus, in operation 734, the next group in the group list is obtained and if this is not the end of the group list (736) the working set is reinitialized to the members of that group (738) not already selected for this partition. Thus, after all groups have been represented in the partition the first time, to maintain the fairness stride, the next member of the partition is selected from the group that hosts the first selected storage element.

When the group list has been exhausted (operation 736) such that each group is represented in the partition by two of its storage elements, the next member of the partition may be selected by repeating the order of the existing partition (740), until the partition request count has been met. Other ways of dynamically partitioning the redundant data fabric may be possible.

An embodiment of the invention may be a machine-readable medium having stored thereon instructions which program one or more processors to perform some of the operations described above. In other embodiments, some of these operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), not limited to Compact Disc Read-Only Memory (CD-ROMs), Read-Only Memory (ROMs), Random Access Memory (RAM), Erasable Programmable Read-Only Memory (EPROM), and a transmission over the Internet.

The invention is not limited to the specific embodiments described above. For example, although the OCL system was described with a current version that uses only rotating magnetic disk drives as the mass storage units, alternatives to magnetic disk drives are possible, so long as they can meet the needed speed, storage capacity, and cost requirements of the system. Accordingly, other embodiments are within the scope of the claims.

What is claimed is:

1. A data storage system comprising:
a plurality of metadata server machines each to store metadata for a plurality of files that are stored in the system;
a plurality of storage elements to store slices of the files at locations indicated by the metadata;
a system interconnect to which the metadata server machines and storage elements are communicatively coupled;
a data fabric to be executed in the metadata server machines, the data fabric to hide complexity of the system from a plurality of client users; and
software to be executed in one of the metadata server machines, to determine a partition across the storage elements in which to store client requested data, wherein the software is to identify some of the storage elements as members of the partition,
the software to continuously collect storage load and usage statistics from the storage elements and repeatedly update a global list of the storage elements sorted according to load and usage criteria, and
wherein the software is to select the members of the partition based on the global list.

2. The storage system of claim 1 wherein the storage elements are arranged as a plurality of groups, each group having a respective two or more of the storage elements that have common installation parameters, wherein the software is to sort the storage elements using knowledge of this grouping.

3. The storage system of claim 2 wherein the common installation parameters comprise one of the group consisting of: power source, model type, and connectivity to the system interconnect.

4. The storage system of claim 2 wherein the software is to select the members of the partition so that each of the members is from a different one of the groups.

5. The storage system of claim 1 wherein the global list is cached in each of the metadata server machines together with software that is to respond to a client request for a new partition by selecting members of the new partition from the cached global list.

6. The storage system of claim 5 wherein the software is to update the global list when the global list has reached a predetermined age.

7. The storage system of claim 5 wherein the software is to update the global list when there has been a change in the storage elements or in the system interconnect.

8. The storage system of claim 2 wherein the storage load and usage statistics to be collected comprise:
the degree to which a storage element has joined the data fabric;
the number of times a storage element has been referenced in a partition;
the degree to which a storage element is committed to data fabric repairs;
the fullness of a data cache in a storage element;
the amount of free space in a storage element;
the amount of read and writes performed by a storage element on behalf of a client of the storage system; and
the number of data errors logged by a storage element.

9. The storage system of claim 2 wherein the software is to update the global list by:
a) initializing a working set to include all of the storage elements; then
b) sorting the working set according to a first storage load or usage criteria; then
c) reducing the working set by removing one or more of the storage elements; then
d) sorting the working set according to second storage load or usage criteria; then
selecting a first member of the global list from the working set.

10. The storage system of claim 9 wherein the software is to update the global list by:
after selecting the first member of the global list from the working set, initializing the working set to include all of the storage elements except for storage elements that belong to the same group as the selected first member; then
repeating b)-d); then
selecting a second member of the global list from the working set.

11. A method for operating a data storage system, comprising:
a) collecting quantitative data about storage load and usage from a plurality of storage elements of the system;
b) ranking the storage elements according to the collected quantitative data;
c) determining a partition across the storage elements in which to store a file requested by a user of the system, by identifying some of the storage elements as members of the partition, wherein the members are selected from the ranking;
d) performing c) for a plurality of user requests; and
e) performing b) to update the ranking, in response to one of the group consisting of 1) the ranking having aged, 2) the system having been repaired, and 3) the system having been upgraded.

12. The method of claim 11 wherein the load criteria comprises one of the group consisting of fullness of a data cache in a storage element, amount of free space in the storage element, degree to which the storage element is committed to repair the system, and number of data errors logged by the storage element.

13. The method of claim 12 wherein the usage criteria comprises one of the group consisting of number of times a storage element has been referenced in a partition, and amount of read and writes performed by the storage element on behalf of a client of the system.

14. An audio video processing system comprising:
a distributed storage system having a data fabric to hide complexity of the system from a plurality of clients, the data fabric to determine a partition across a plurality of storage elements of the system in which to store client requested data, the data fabric to collect storage load and usage statistics from the storage elements and use the collected statistics to maintain a list of the storage elements sorted from more-suitable-for-use-in-a-partition to less-suitable-for-use-in-a-partition, wherein the data fabric is to select members of the partition from the list; and
a media server to obtain data from audio and video capture sources and to act as a client to the data fabric in requesting storage of said data.

15. The audio video processing system of claim 14 wherein the data fabric is to use the list to determine partitions for a plurality of client requests until the list is updated, the data fabric to update the list in response to one of the group consisting of 1) the list having aged, 2) the system having been repaired, and 3) the system having been upgraded.
